(19) United States
(12) Patent Application Publication
(10) Pub. No.: US 2006/0192306 A1
(43) Pub. Date: Aug. 31, 2006

(54) Manufacturing methods for embedded optical system

(75) Inventors: Eugene Giller, Needham, MA (US); Noa M. Rensing, Newton, MA (US); Paul M. Zavracky, Norwood, MA (US)

Correspondence Address: WEINGARTEN, SCHURGIN, GAGNEBIN & LEBOVICI LLP, TEN POST OFFICE SQUARE, BOSTON, MA, 02109, US

(73) Assignee: THE MICROOPTICAL CORPORATION

(21) Appl. No.: 11/065,847

(22) Filed: Feb. 25, 2005

(51) Int. Cl. B29D 11/00

(52) U.S. Cl. 264/1.7

(57) ABSTRACT

A method for producing a solid optical system with embedded elements is provided. The embedded elements may include inorganic, polymer, or hybrid lenses, mirrors, beam splitters and polarizers, or other elements. The embedding material is a transparent high quality optical polymer.

### CROSS REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

Fabricating optical systems such as head mounted displays often requires assembling several optical components. See for example U.S. Pat. Nos. 6,538,624; 6,462,882; 6,147,807. Some optical system designs include an air gap between the optical components. This creates the necessity for a housing to hold the elements in mechanical alignment as well as a method of protecting the inner surfaces of the components from dust, oil and other contamination. Other optical systems allow the gap to be filled by some other medium. These systems can be built, for example, by embedding reflective, diffractive, polarizing or other optical components into an optically transparent solid medium. See for example U.S. Pat. Nos. 5,886,882, 6,091,546, and 6,384,922. An advantage of this approach is that the resulting system is a monolithic solid part. The relative positions of the elements are permanently fixed and there are no exposed inner surfaces to become contaminated with dust or condensation.

In practice, the actual manufacturing of embedded optical systems may be quite difficult. It is necessary to take into account the differences of the coefficients of thermal expansion in the embedded optical components and embedding medium, adhesion strength between the embedded optical components and embedding medium, birefringence and distortion in the final product, aging processes and so on. The most obvious embedding media are polymer compounds. However, these may have a number of major disadvantages. A critical concern is shrinkage of the liquid monomer or prepolymer during the polymerization and cross-linking step. This can cause optical distortion and change the relative positions of the embedded components. In addition polymerization that initiates on the surface of the embedded components may lead to preferred molecular orientation in the solidified polymer. This may result in birefringence in the completed part.

Preferably, for the purpose of fabricating head mounted display systems, the cured embedding material must have physical and optical properties that are similar to the materials used in the production of ophthalmic lenses. The material must have high transparency in the visible spectra (transmission at least 85%), high Abbe number to avoid chromatic aberrations, good impact strength to pass the FDA ball drop test, low color or yellowishness index, good resistance to static stress and scratch resistance, and low water absorption level. The most common optical polymer currently used for ophthalmic lens production is diethylene glycol bis (allyl carbonate) also known as CR-39. This material has 13-16% shrinkage upon curing, making it challenging to use for embedded systems. The other commercially available polymers for lens casting have shrinkage at least 6% that is also excessive for the fabrication of embedded systems.

There are several approaches to reduce shrinkage on curing in the optical polymers. For example, Herold et al. in U.S. Pat. No. 5,952,441 suggested partially pre-polymerizing a mixture of ethylenically unsaturated compounds prior to casting embedded systems, to minimize shrinkage during the final cure. The pre-polymerization process is not easy to control and polymerization does not stop completely when the desired degree of polymerization had been achieved. Also, due to the requirement for a low viscosity prepolymer material, the cured polymer may still have substantial shrinkage.

Another approach suggested by Soane in U.S. Pat. No. 5,114,632 is to continue feeding liquid material into the mold during the curing process to compensate for the shrinkage. Although it is probably possible to avoid mechanical stress by this approach it will cause variation in the molecular weight of the polymer in the body of the device that will result in optical index variation and image distortion.

Soane and Huston in U.S. Pat. No. 6,380,314 proposed a method of near-net shape casting from a reactive plasticizer within an entangled dead polymer. In this approach solid state fully polymerized material is dissolved in the polymerizable compound or composition used to embed the optical components, thus reducing the amount of shrinkage during subsequent cure. However, in this case the curable mixture is semi-solid and can not be used in embedded optical systems such as for head-mounted displays.

### SUMMARY OF THE INVENTION

The present invention relates to a method of producing an optical system for head mounted displays that includes inorganic optical components or polymer optical components such as plates, mirrors, or lenses, embedded in the transparent polymeric, liquid or gel matrix (FIGS. 1, 2). It further relates to a general production method for an ophthalmic lens or other embedded optical system that consists of inorganic, polymer or hybrid optical components that include but are not limited to lenses, mirrors, beam splitters and polarizers embedded in a transparent polymeric, gel or liquid matrix (FIG. 3) where the encapsulating material is also in the optical path. Other optical elements may also be embedded to solve specific problems. These elements could include but are not limited to diffractive elements, switchable mirrors and electrochromic or photochromic films and elements, elements and waveguides formed by the differences of the refractive indexes, fiberoptic bundles, and elements based on total internal reflection phenomena.

The steps to create an embedded optical system include cleaning and pretreatment (optional) of the optical elements, positioning of the optical elements prior to encapsulation, mold assembly, a molding or encapsulating process, overcasting (optional), surface finishing or polishing (optional), and surface coating (optional) (FIG. 4).

### DESCRIPTION OF THE DRAWINGS

The invention will be more fully understood from the following detailed description taken in conjunction with the accompanying drawings, in which:

FIG. 1 is a frontal view of a see-through embedded eyeglass frame-mounted display incorporating embedded optical elements according to the present invention;

FIG. 2 is a frontal view of a see-around, embedded eyeglass frame-mounted display incorporating embedded optical elements according to the present invention;

FIG. 3 is a cross-sectional view of an index-matched gel or liquid filled system;

FIG. 4 is a flowchart of the manufacturing process for the embedded optical systems;

FIG. 5 is a side view of the prismatic element setup with vacuum support;

FIG. 6A is a side view of the plate element see-through system positioned in the support fixture;

FIG. 6B is a side view of the plate element see-through system positioned on the mold plate;

FIG. 7A is a side view of the plate element see-around system positioned in the support fixture;

FIG. 7B is a side view of the plate element see-around system positioned on the mold plate;

FIG. 8 is a cross-sectional view of the see-around elements positioned in the precut or premolded openings in the mold plate;

FIG. 9 is a cross-sectional view of the see-around elements positioned in the precut or premolded openings in the lens base;

FIG. 10 is a cross-sectional view of the insert removed from the lens base;

FIG. 11 is a cross-sectional view of the assembled mold with positioned optical elements;

FIG. 12 is a cross-sectional view of the cured lens setup for overmolding;

FIG. 13 is a cross-sectional view of the lens that has embedded optical elements and ophthalmic correction element; and

FIG. 14 is a cross-sectional view of a mold setup during a layer-by-layer molding process.

### DETAILED DESCRIPTION OF THE INVENTION

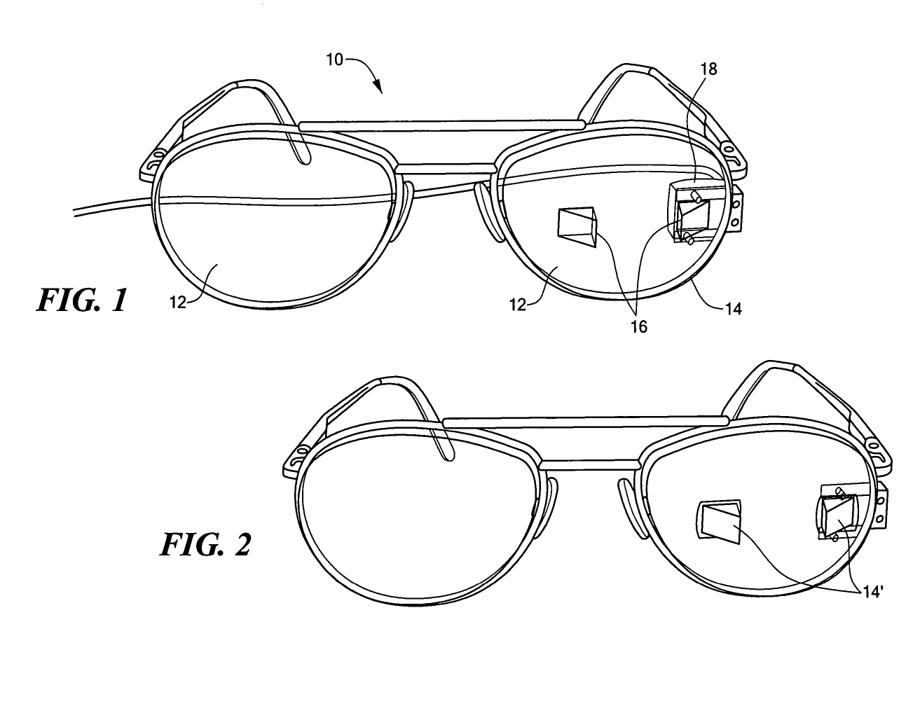

FIG. 1 illustrates a pair of eyeglasses 10 having two eyeglass lenses 12 retained within an eyeglass frame 14. In one lens, optical elements or components 16 are embedded to receive an image from a display 18 and transmit the image to the wearer's eye. FIG. 1 illustrates a see-through system, in which the wearer can also view the ambient scene through the optical elements. FIG. 2 is similar to FIG. 1, but illustrates a see-around system in which the embedded optical elements 14′ block a portion of the light from the ambient scene and the ambient scene is viewed around the optical elements. The optical elements, which may be, for example, lenses, mirrors, beam splitters and polarizers, are formed separately in any manner known in the art. The elements are then embedded in the lens as described further below.

To avoid contamination on the embedded optical parts it may be necessary to clean the optical elements to be embedded prior to the embedding process. See step 1 in FIG. 4. The cleaning may be carried out in any appropriate manner, as would be known in the art. Depending on the type and material of the element, it can be cleaned by ultrasonic cleaning, washing with low foaming, easily rinsed detergent, followed by rinsing and drying with lint-free cloth, or cleaning with an alcohol based cleaner or organic solvent and drying.

Prior to the molding, the elements to be embedded may be pretreated to improve adhesion by various techniques. Improving the chemical and physical bonding between embedded elements and the embedding substrate prevents delamination and formation of cavities that causes degradation of the optical properties. The embedded optical parts can be treated with corona discharge, flame, plasma, or the surface may be etched with alkali solution, as would be understood by those of skill in the art. Also, primers, surface grafting with siloxane, silane, borate, metallorganic and other coupling agents can be used if necessary, as also would be understood by those of skill in the art.

The optical elements are then positioned for molding. See step 2 in FIG. 4. In the preferred embodiment of the current invention, the optical elements are aligned by fixing them in the correct relative position to a plate, which then forms one of the faces of the casting mold. The optical elements may be attached to the mold plate either by mechanical means or through the use of adhesives. Adhesives could be thermal or room temperature cure adhesives, UV, visible or radiation cure adhesives, or moisture curable adhesives. The refractive index of the adhesive should be at least within 0.1 of the refractive index of the cured filling compound, and preferably within 0.05 and even more preferably within 0.01. The filling casting compound composition itself can be used to affix the element position in order to more precisely match the optical and mechanical properties.

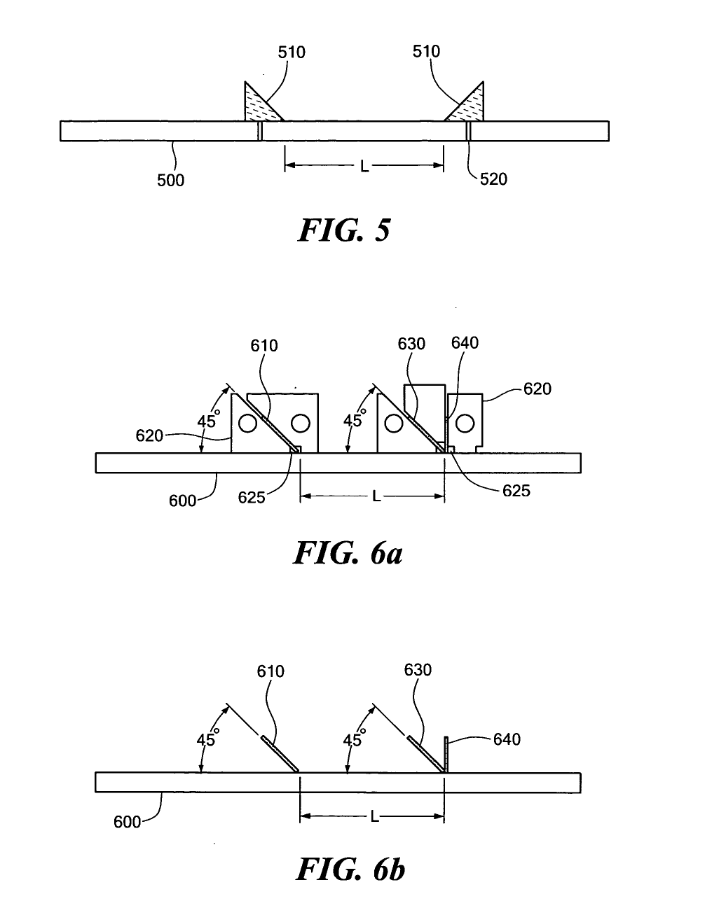

During positioning, the optical elements can be supported in place by vacuum. FIG. 5 illustrates two prismatic elements 510 positioned on the base plate 500 supported by vacuum delivered through the hollow openings 520. Elements can be cast with continuous vacuum support or can be glued onto the plate, allowing for casting without vacuum.

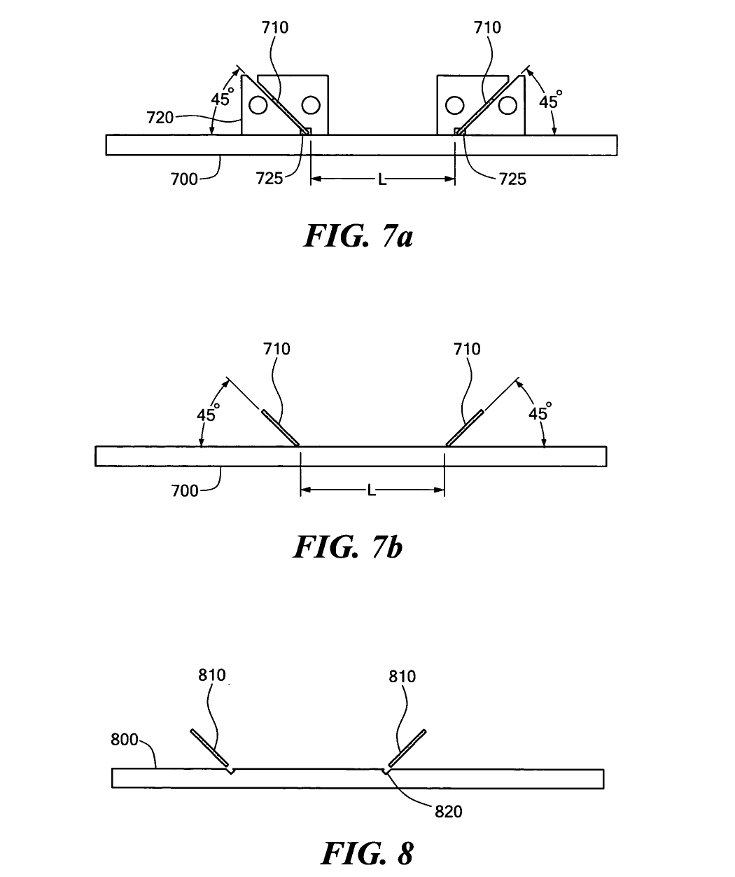

The elements may be mechanically aligned by a variety of ways, for example, using a mechanical fixture, pick-and-place equipment or other replication equipment prior to gluing. FIG. 6A illustrates the use of a fixture 620 in the positioning of the elements for a see-through lens. The first surface mirror 610, beamsplitter 630, and Mangin mirror 640 are mounted on the base plate 600 with the support of the mechanical fixture 620. Then a small amount of optical adhesive is introduced at the base 625 of each of the optical elements to support it on the base plate. After the adhesive is cured, the support fixtures can be removed and the base plate assembly as shown in FIG. 6B is ready to be assembled in the final mold. A similar process may be used for a see-around optical system as shown in FIG. 7 or any other desired embedded optical system. In FIG. 7A, optical elements 710 are mounted on the base plate 700 with fixtures 720, and adhesive is introduced at the base 725. After curing of the adhesive, the fixtures are removed, and the base plate assembly as shown in FIG. 7B is ready for molding. In a further embodiment, FIG. 8 shows two first surface mirrors 810 placed into the openings 820 on the base plate 800. The positioning and alignment of the various elements required for the optical design may take place in one or more steps.

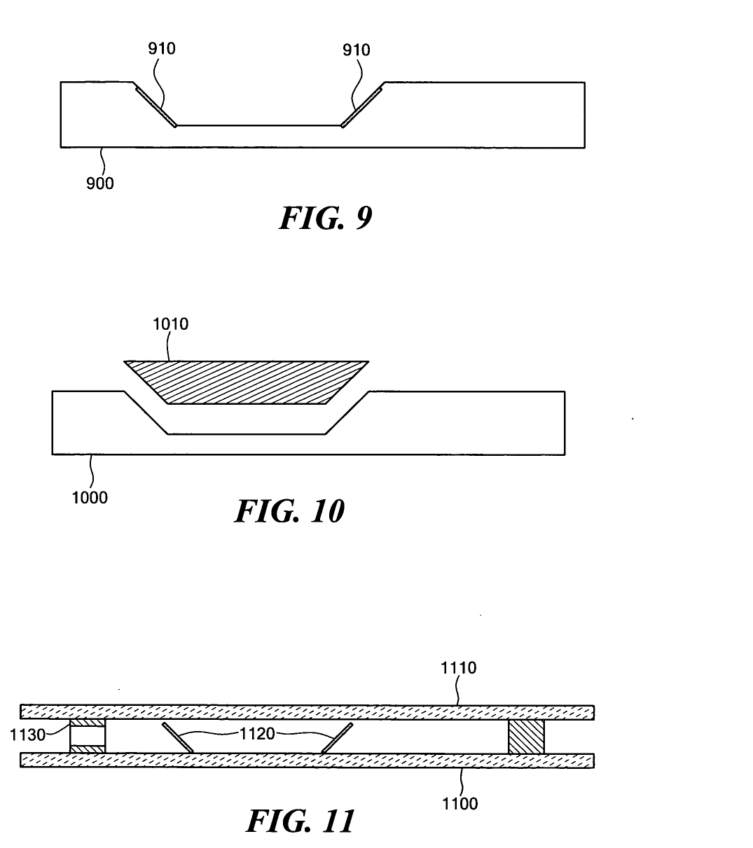

Another way to accomplish the positioning of the optical elements is to place them into openings cut into a lens fabricated by methods described here or known in the art, including casting, injection molding, and/or cutting. This approach is shown in FIG. 9. Two optical elements 910 placed into openings cut in the part 900 after casting. Alternatively, an opening can be produced by the placement of one or more dummy removable elements 1010 into the casting mold and then removing them from the cast part 100 after curing as shown in FIG. 10. The dummy elements may be chosen or made to provide desirable surface properties; for example, a highly polished insert may be used to create an optical quality window upon removal. This window may, for example, be used to couple light from another part of the optical system into the embedded optical system. A similarly formed flat or curved surface may also be coated to form a mirror required in the optical design.

The initial position of the elements can be adjusted to compensate for shifting due to shrinkage during the curing process. The positioning and alignment of the elements may also utilize optical methods to check the alignment of the elements. For example, a laser beam or autocollimator may be used to check the angle of fold mirrors or the centration of curved surfaces. Optionally, active optical alignment may be used, in which process the mechanical position of the elements may be adjusted while monitoring the optical performance of the system. The optical performance of the aligned system or subsystem during alignment will generally differ from the optical performance of the completed parts. In this case, optical modeling may be necessary to calculate the expected performance of the subassembly on the mold plate and to design appropriate alignment procedures.

In step 3 (FIG. 4), the mold assembly is constructed. A preferred mold shape for this process is shown in FIG. 11. The mold comprises the base plate 1100 with the optical elements 1120 positioned on it as discussed above and a second cover plate 1110. The two plates are separated by an annular spacer 1130. Generally, the plates are flat and parallel and the spacer has a uniform thickness; however, depending on the application, one or both plates can have a curvature and/or the spacer can have a non-uniform thickness, for example to provide a wedge-shaped part. The spacer creates a cavity in which the part is cast and is provided with at least one opening to allow filling of the mold. Typically, the elements to be embedded are affixed to one of the plates, here designated the base plate. Optionally, additional elements may be affixed to the second plate. In this case, an alignment is required during the mold assembly. The thickness of the part is determined by the height of the spacer. The mold parts may be held together by mechanical fasteners, for examples screws and/or clamps. Alternatively, the mold parts may be held together using the pressure of the molding process. The mold preferably can be assembled from materials that have low adhesion to the cured filling composition. The mold can also be precoated with silicone, hydrocarbon, fluorinated hydrocarbon or other suitable mold release agents. The mold surface finish, material, and release agents may be chosen to yield high quality polished surfaces in the finished part. Alternatively, if the finished part is to be post-processed in a fashion that removes the surface material, as discussed below, the mold material, surface finish, and release agent may be selected to enhance the polymerization process and the bulk optical properties of the part without regard to the surface quality. For example it may be desirable to use metal mold parts to improve thermal control of the process.

The mold is then filled with a suitable low-shrink polymerizable optical casting compound (step 4, FIG. 4). Suitable casting compounds are known in the art. The casting compound used to fill the mold should have low viscosity to evenly fill the mold, and should result in a part with the desirable properties described above, including uniform optical index, low stress, good durability, low crystallinity, etc. Any method of polymerization can be used in the invention. Those methods include for example condensation polymerization, free radical polymerization, anionic polymerization and cationic polymerization. To be suitable in this embodiment, the shrinkage on cure should be below 6.0%, preferably below 4.0% and most preferably below 1.5%. Terminating agents as known in the art may be added to reduce the average molecular weight in order to promote a more uniform, amorphous material with lower birefringence.

An acceptable alternative to a highly amorphous, non-birefringent embedding material would be a highly oriented material with carefully controlled birefringence. In this case, it is desirable that the material polymerize along a preferred direction, usually (although not necessarily) parallel to the primary optical axis direction. This type of material may be highly birefringent, but does not affect the direction of polarization of the light or the image quality because all the ray paths see the same optical index distribution. Such an approach is used, for example, in the fabrication of optical fibers, where the fibers are subjected to mechanical stress to orient the material's polymerization direction and preferred optical axis with the direction of propagation of the light. The preferred orientation of the embedding matrix may be established by a variety of methods known in the art, for example prior surface preparation, thermal gradients, pressure or stress gradients, or magnetic or electrical methods. In this case, the casting compound should have a high level of molecular orientation.

Additives may be added to the casting composition to adjust certain properties, as would be known in the art. For example, polymeric and monomeric non-reactive optical plasticizers can be added to the composition to reduce internal stress in the polymer, as would be known in the art. The optional addition of plasticizers can be used to adjust the refractive index, for example, to match the refractive index of the embedded compounds. Examples of such plasticizers include monomeric plasticizers diisononyl phthalate, bis (2-ethylhexyl) cebacate, triisohexyl trimellitate, dipropyleneglycol dibenzoate, 1,2 propanediol dibenzoate, 2-nitrophenyl octyl ester, 2-butoxyethyl adipate, osooctyl tallate, diisodecyl glutarate, dicycloxyethyl phthalate, tricresylphosphate, polymeric plasticizers—epoxidated soybean oil, Bayer's phthalic polyesters such as plasticizer CEL and Ultramol® PP, Bayer's adipic polyesters such as Ultramoll® I and Ultramoll® II. Reactive plasticizers such as polyethylene glycol dioleate, Ultramoll® M and Cardolite® NC-513 can also be used to relieve internal stress-birefringence and adjust the refractive index.

Matching the refractive index and Abbe number dispersion of the embedded elements and the cured casting compound where possible is important for both cosmetic and optical reasons. This is likely to be desirable when the embedded element uses a clear glass or plastic component for mechanical support of a coating or another element. For example, if a glass plate coated with a reflective coating is embedded in the system, using an index matched glass and polymer matrix pair reduces the appearance of the glass and creates the impression of the reflective film floating unsupported within the matrix. Furthermore, an index mismatch between the glass support element and the embedding matrix can create distortions in both the display image and the see-through image because of prismatic and similar optical effects. The refractive index of the optical elements should be at least within 0.1 of the refractive index of the cured filling compound, and preferably within 0.05 and even more preferably within 0.01.

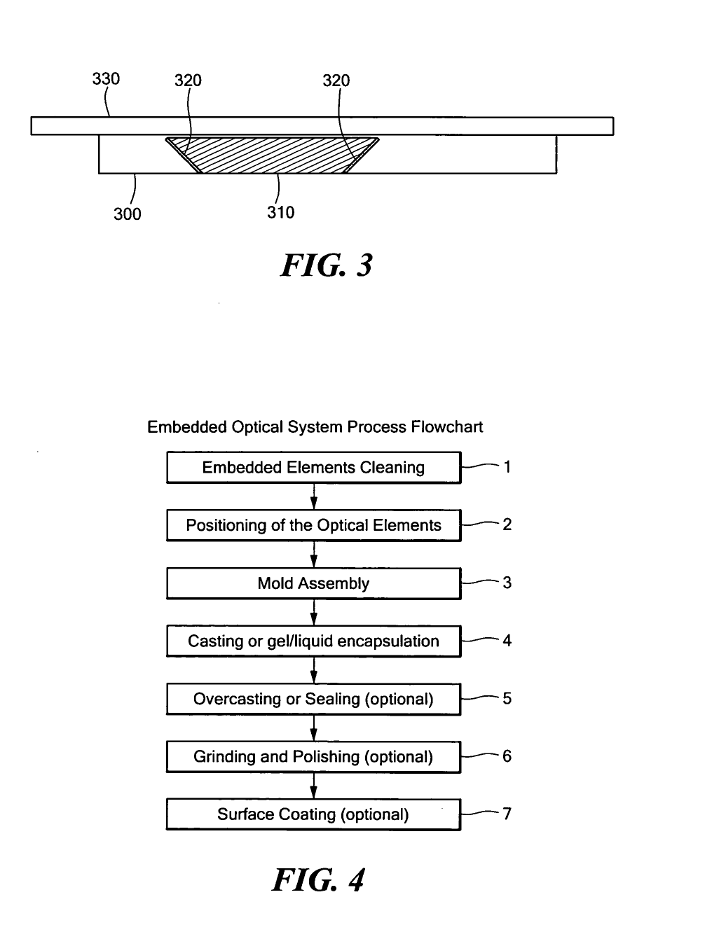

Alternatively, the monomer can also be polymerized to gel consistency to be used in gel filled systems. Those systems could be formed by polymerization, partial polymerization, polymerization in the presence of plasticizers or reactive or non-reactive dilutants or by swelling or dissolving polymer in the plasticizer or solvent. FIG. 3 illustrates an example of the above system where optical elements 320 were positioned in the opening in the cast base element 300. Then the lens is covered with a transparent cover plate 330 and the resulting cavity is filled with index matched gel or liquid 310. The use of gels or liquids allows significant reduction in optical distortion and/or birefringence; however it requires the use of a hard shell lens and proper sealing of the system.

Preferably, the plasticizer is compatible with the polymer matrix and is used in concentrations that will not cause phase separation or migration of the plasticizer inside the polymer or to the surface. The polymer plasticizer concentration can be 1 to 60%, preferably 3 to 30%, and more preferably 5 to 25%. However for gels the plasticizer concentration can be as high as 95%. A mixture of different plasticizers can also be used in the composition. It is preferable to select plasticizers that will enhance hydrophobic properties in the material. This will reduce moisture absorption in the final polymer, which is important for the environmental stability and prevents refractive index variations.

Other additives may be used to control the polymerization process. To reduce the heat of reaction that may cause stress-birefringence in the material, inhibitors may be added to the polymer composition, the choice of inhibitor depending on the polymer system used, as would be known in the art. Inhibitor concentrations are usually below 5.0%, preferably below 3.0%. For some polymer systems, it may be necessary or desirable to use catalysts to conduct polymerization, achieve high conversion level or accelerate the polymerization process, the choice of catalyst depending on the polymer system used, as would be known in the art. The catalyst concentration in the system should usually fall below 3.5%, and preferably below 1.0%. In some polymer systems, particularly for free radical polymerization, it may be helpful to add a chain transfer agent, the choice depending on the polymer system used, as would be known in the art. Usually their concentrations should be below 0.5%

Stabilizers can be used in the system to prevent changes in the optical, mechanical, or chemical properties of the polymer over time, as would be known in the art. Organosilicone and metal-organic coupling agents may be added to the resin in concentrations that do not affect the visible light transmission of the finished part, as would be known in the art. These additives reduce the mechanical stress in the finished embedded optical system that contributes to refractive index variations and birefringence. Although the usual concentrations of the coupling agents are between 0.3 to 5.0%, they can be added in concentrations up to 35.0% and be incorporated into the polymer by chemical bonding.

To avoid entrapment of air in the polymer, the casting compound should be degassed prior to introduction into the mold, as would be known in the art, and the casting process carried out under pressure. In addition, air-release agents can be added to the casting mixture, as would be known in the art. Preferable concentrations for the above materials are 0.1 to 3.5%.

The casting step (step 4, FIG. 4) includes polymerization, curing, and, optionally, post curing processes. Additional reduction in shrinkage can be achieved by applying a constant pressure to the casting mixture during the polymerization process. This helps compensate for the shrinkage that normally occurs in the prepolymer before solidification. Another advantage is that the pressure squeezes out the entrapped air.

Typically, the polymerization process occurs at a temperature greater than room temperature. Differential thermal expansion during the cure cycle can result in locking in mechanical stress as the system returns to room temperature. For heat curing systems, the temperature must be kept at the low end of the allowable solidification temperature to avoid exothermic reactions that may cause optical and mechanical stress. If post-curing is required, the temperature profile must be selected to achieve high conversion level while keeping the heat generated by the exothermic reaction to a minimum. It is desirable to accomplish solidification of the composition at room temperature if possible, or alternatively at the minimum temperature required for the process. Temperature ramps during polymerization, cure, and post-cure processing must be controlled to limit or minimize the introduction of mechanical stress in the finished part, as would be known in the art. The particular temperatures and pressures and process rates depend on the particular polymer system used, as would be appreciated by those of skill in the art.

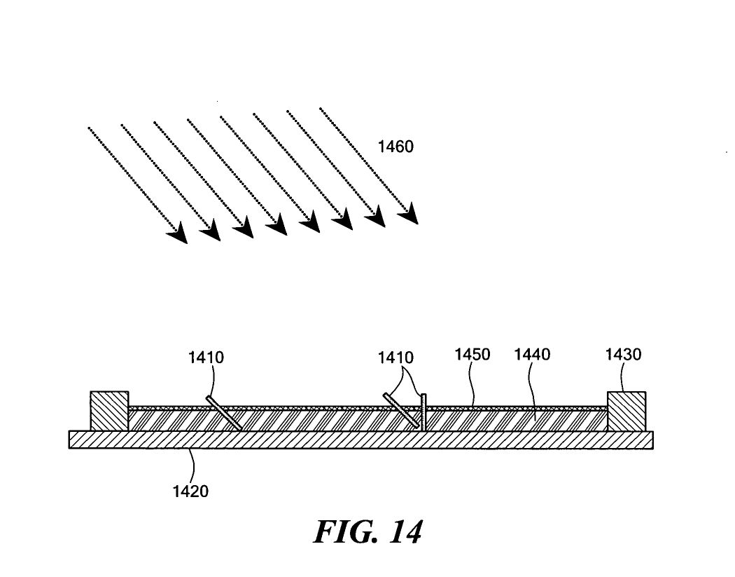

For radiation curable systems, for example UV curable systems, the energy level must be selected to achieve complete monomer conversion. It is preferable to cure such systems in thin layer increments. In this case, the casting compound is added to the mold assembly in layers, each layer being cured before the next layer is added. The optical elements are in this manner gradually embedded in the casting compound. Referring to FIG. 14, optical components 1410 positioned on a mold plate 1420 are placed within a mold ring 1430. An incremental layer 1450 of the uncured monomer is added to the system on top of the previously cured polymer 1440 and subjected to heat, radiation, or chemical curing conditions 1460 as required by the material. The process is repeated for as many layers as necessary to build up the desired thickness. The part may then be machined, ground, polished, or otherwise post-processed to remove any uneven surface due to the casting process. It is furthermore possible to use different formulations for different layers of the material in order to achieve desirable cosmetic, mechanical, or optical effects. For example, some layers may be tinted in order to reduce the overall light transmission of the system, as would be desired for sunglasses.

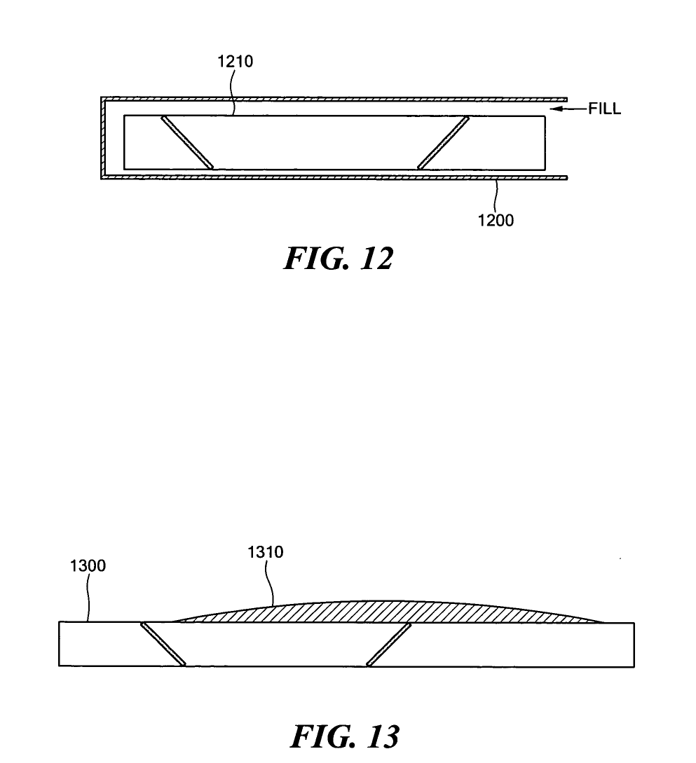

After molding, the cured component or puck may optionally be post-treated in various ways. To prevent the appearance of surface imperfections, the cured puck 1210 can be placed in an overmold 1200 and then overcast with the same casting material or in a different material with optical index matched to the embedding material, as shown in FIG. 12. Optionally, the part may be overcast with polymer compounds having different refractive indexes and mechanical properties from the embedding compound. For example, the overcasting polymer may be chosen to be harder than the embedding compound to enhance the durability of the finished part. In another embodiment, the index of the overcasting material may be chosen to be lower than the main system to reduce reflections at the interface. It is preferable to carry out the overcasting at room temperature to avoid the appearance of surface imperfections caused by the differences in the thermal expansion of the different materials. It is also possible to overcast the system several times with the same or different materials. It may be beneficial to add dyes, including photochromic or electrochromic dyes in the overcast material. In an alternative approach, the additional layer may be cast onto the mold plates first, prior to casting the main optical system. The layer added by overcasting may be shaped to provide additional optical properties such as ophthalmic correction. Alternatively, ophthalmic correction may be added by grinding, polishing, or diamond turning the added layer.

An optional grinding or polishing step may be desired. (Step 6, FIG. 4) If there are apparent imperfections on the surface of the material due to the shrinkage of the embedding composition or due to a difference in the thermal expansion coefficients of the embedded materials and the embedding composition it may be necessary to polish the surfaces of the puck. The polishing process can be used to planarize the surface of the puck to prevent distortions due to refraction at an irregular surface. Another reason may be to remove a highly stressed layer of material that introduces distortion in the optical path due to passage of the light rays through inhomogeneous material. The thickness of the cast part may be adjusted to allow for post-casting polishing. The puck may also be polished, ground, or diamond turned to give a specific surface shape for desirable optical properties such as ophthalmic correction.

A surface coating step may be desirable (step 7, FIG. 4). The appearance, optical properties, chemical resistance, wear resistance, oxygen and moisture impermeability of the final products can be enhanced by using conformal, planarization and other types of coatings. They can be coated with anti-scratch, anti-smudge, antireflection, or polarization coatings or other types of functional or decorative coatings. These coating can be applied by dip coating, spin coating, spray coating, roll-coating, vacuum deposition, sputtering or by other methods. Products can also be tinted. Also, a protective film that may optionally be previously provided with any of the above types of coatings can be laminated onto the surface of the final device.

A corrective optical element 1310 can be permanently or temporary attached to the above system 1300 as shown in FIG. 13. The corrective element may consist of a plano-convex or plano-concave lens as required for the specific correction and a planar optical system. Alternatively if the optical system is not planar, the corrective element may be shaped to conform to the optical system surface. Other options for the corrective element include the use of diffractive or Fresnel lenses, which may also be so shaped so that one side conforms to the external surface of the optical system to allow lamination. The corrective element can be placed on the inner viewing surface to correct both projected and surrounding images or on the outside surface to correct the see-through view only or may allow for corrections on both surfaces, for example in the case of a strong prescription or the need for cylindrical correction. The corrective element could be attached with glue, pressure sensitive adhesive, and surface tension or molded on the systems.

If the element is molded on the surface of the planar system, a transparent film can be placed on the planar surface between the composite optical system puck and the added optical element by means of gluing or laminating before overmolding the corrective element. This intermediate film allows for the easy removal of the corrective optical element without destroying the planar optical system. Also, in planar optical systems that use total internal reflection (TIR), the intermediate film may have a refractive index that is lower than the refractive index of the planar system, to maintain the optical conditions that allow for TIR.

The invention is not to be limited by what has been particularly shown and described, except as indicated by the appended claims.

What is claimed is:

1. A method of producing a solid optical system having embedded optical elements comprising:
providing a mold assembly having a mold cavity;
attaching one or more optical elements to a wall of the mold cavity, the optical element comprising an inorganic material, a polymer, or a hybrid inorganic polymeric material;
introducing an optical polymerizable casting compound into the mold cavity; and
curing the casting compound to provide an optical component.

2. The method of claim 1, wherein the mold assembly comprises a base plate, a cover plate, and a spacer element between the base plate and the cover plate, an opening disposed in the spacer element to allow filling of the mold cavity.

3. The method of claim 2, wherein the base plate comprises a flat plate or a shaped plate.

4. The method of claim 2, wherein the cover plate comprises a flat plate or a shaped plate.

5. The method of claim 2, wherein the spacer element comprises an annular element.

6. The method of claim 2, wherein the spacer element comprises a wedge shape.

7. The method of claim 2, wherein the one or more optical elements are attached to the base plate, and the base plate, the spacer element, and the cover plate are assembled to form the mold cavity.

8. The method of claim 2, wherein the one or more optical elements are attached to the base plate with an optical cement.

9. The method of claim 2, wherein the one or more optical elements are attached to the base plate with a material identical to the optical polymerizable casting compound.

10. The method of claim 2, wherein the one or more optical elements are attached to the base plate with a vacuum.

11. The method of claim 2, wherein the base plate includes a recess therein and the one or more optical elements are attached to the base plate by insertion into the recess in the base plate.

12. The method of claim 2, wherein the one or more optical elements are attached to the base plate with a removable mechanical fixture.

13. The method of claim 2, wherein one or more further optical elements are attached to the cover plate.

14. The method of claim 13, wherein the base plate and the cover plate are aligned during assembly of the mold assembly to optically align the one or more optical elements and the one or more further optical elements.

15. The method of claim 1, wherein positions of the one or more optical elements are adjusted to achieve a determined optical performance of the system.

16. The method of claim 1, wherein positions of the one or more optical elements are adjusted to account for shrinkage during molding or curing.

17. The method of claim 1, wherein in the introducing step, the optical polymerizable casting compound comprises a liquid or gel.

18. The method of claim 1, wherein the one or more optical elements include a lens, mirror, beam splitter, or polarizer.

19. The method of claim 1, wherein the one or more optical elements and the optical polymerizable casting compound are selected to have matching refractive indexes in the optical compound.

20. The method of claim 19, wherein the matching refractive indexes are within 0.1.

21. The method of claim 19, wherein the matching refractive indexes are within 0.05.

22. The method of claim 19, wherein the matching refractive indexes are within 0.01.

23. The method of claim 1, wherein the one or more optical elements and the optical polymerizable casting compound are selected to have matching optical dispersion.

24. The method of claim 1, wherein the optical polymerizable casting compound is selected to have low crystallinity.

25. The method of claim 1, wherein the optical polymerizable casting compound is selected to provide low birefringence.

26. The method of claim 1, wherein the optical polymerizable casting compound is selected to have low shrinkage.

27. The method of claim 26, wherein the optical polymerizable casting compound has a shrinkage on curing of less than 6.0%.

28. The method of claim 26, wherein the optical polymerizable casting compound has a shrinkage on curing of less than 4.0%.

29. The method of claim 26, wherein the optical polymerizable casting compound has a shrinkage on curing of less than 1.5%.

30. The method of claim 1, wherein the optical polymer casting compound is selected to have a low level of molecular orientation.

31. The method of claim 1, wherein the optical polymer casting compound has a high level of molecular orientation controlled to achieve uniform birefringence and a preferred optical axis.

32. The method of claim 1, wherein in the introducing step, a plasticizer is introduced with the optical polymerizable casting compound.

33. The method of claim 32, wherein the plasticizer is selected to have a refractive index matching a refractive index of the optical polymerizable casting compound to reduce birefringence.

34. The method of claim 32, wherein the plasticizer is selected to have a refractive index different from a refractive index of the optical polymerizable casting compound to adjust a refractive index of the optical component to match a refractive index of the one or more optical elements.

35. The method of claim 1, further comprising the step of applying pressure to the mold cavity, whereby shrinkage of optical polymerizable casting compound before solidification can be controlled.

36. The method of claim 1, further comprising pretreating the one or more optical elements with a coupling agent to reduce stress and birefringence in the optical component.

37. The method of claim 1, further comprising pretreating the one or more optical elements with a coupling agent to reduce microdelamination.

38. The method of claim 1, further comprising introducing a coupling agent into the mold cavity to reduce microdelamination.

39. The method of claim 1, further comprising removing the optical component from the mold assembly, and polishing or grinding the optical component.

40. The method of claim 1, further comprising removing the optical component from the mold assembly, and coating or overcasting the optical component with a further optical material.

41. The method of claim 1, further comprising adding an ophthalmic correction to the optical component.

42. The method of claim 1, further comprising adding an ophthalmic correction to the optical component by laminating a plano-convex or plano concave lens to one or both sides of the optical component.

43. The method of claim 1, further comprising forming an additional thickness to the optical component and grinding, polishing, or diamond turning an optical surface of the additional thickness to provide an ophthalmic correction.

44. The method of claim 43, wherein the thickness is provided during molding.

45. The method of claim 43, wherein the thickness is provided by overcasting the optical component after molding.

46. The method of claim 43, wherein the thickness is added to the mold cavity.

47. The method of claim 43, further comprising attaching an intermediate clear optical film to the optical component, and molding a corrective ophthalmic element on the surface of the film.

48. The method of claim 1, wherein an intermediate clear optical film having a refractive index lower than a refractive index of the optical component is attached to the optical component, and attaching a corrective ophthalmic element to the film.

49. The method of claim 48, wherein the film is attached by glue, pressure sensitive adhesive, or surface tension.

50. The method of claim 1, wherein the optical polymerizable casting compound is introduced into the mold cavity in incremental thin layers, each layer cured prior to the introduction of the next layer.

51. The method of claim 50, wherein all the layers are formed from an identical material.

52. The method of claim 50, wherein some of the layers are formed from different materials or compositions.

53. The method of claim 50, wherein some of the layers are cured by different processes.

54. A device produced by the method of claim 1.

55. A method of producing a solid optical system having embedded optical elements comprising:
providing a mold assembly having a mold cavity;
attaching one or more removable elements to a wall of the mold cavity;
introducing an optical polymerizable casting compound into the mold cavity;
curing the casting compound to provide an optical component;
removing the optical component from the mold assembly;
removing the one or more removable elements from the optical component, leaving a cavity;
attaching one or more optical elements to the optical component within the cavity.

56. The method of claim 55, wherein removing the removable element creates an optical window capable of optically coupling the optical system to another optical system.

57. The method of claim 55, wherein removing the removable element forms a highly polished surface on the optical component, and further comprising coating the highly polished surface to form a mirror.
